(19) United States
(12) Patent Application Publication
(10) Pub. No.: US 2008/0283234 A1
(43) Pub. Date: Nov. 20, 2008

(54) Heat sink and method of making same

(75) Inventors: Fumihiko Sagi, Iwaki (JP); Masami Murayama, Hitachi (JP); Junichi Katougi, Higashiibaraki-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable MEC-Tech, Ltd., Ibaraki (JP)

(21) Appl. No.: 11/987,388

(22) Filed: Nov. 29, 2007

(30) Foreign Application Priority Data
May 17, 2007 (JP) 2007-131586

(51) Int. Cl. F28F 1/30; B23P 15/26

(52) U.S. Cl. 165/182; 29/726

(57) ABSTRACT

A heat sink has a heat pipe inside of which a working fluid is filled and which is extended by a predetermined length from a heat source in a heat radiation direction, and a radiation fin having a mountain portion and a valley portion formed in a longitudinal direction of the heat pipe, the mountain portion and the valley portion forming a continuous waveform. The radiation fin further has a step portion for fitting and retaining the heat pipe thereinto. A method of making the heat sink includes shaping the mountain portion and the valley portion on a strip plate member with a thermal conduction property in a longitudinal direction of the plate member to form the radiation fin, placing the radiation fin between an upper mold and a lower mold, wherein the upper mold has a convex member with a same shape as the heat pipe and the lower mold has a step-shaping member for shaping the step portion, pressing the radiation fin by the upper mold and the lower mold to form the step portion on the mountain portion, and fitting and retaining the heat pipe into the step portion.

The present application is based on Japanese patent application No. 2007-131586 filed on May 17, 2007, the entire contents of which are incorporated herein by reference.

### BACKGROUND OF THE INVENTION

1. Field of the Invention

This invention relates to a heat sink that is used as a heat radiation parts for electronic devices, low-profile, lightweight and excellent in heat transfer property. Also, this invention relates to a method of making the heatsink.

2. Description of the Related Art

Heat sinks serve to radiate heat generated from a heat source to suppress temperature rise of the heat source. In general, they are composed of a radiation fin formed of an aluminum plate or a copper plate and a heat pipe attached to the radiation fin and including a working fluid encapsulated therein.

FIG. 11A shows a conventional heat sink 111a that is composed of plural separate radiation fins 112 each of which is U-shaped in cross section and has a heat pipe bonding groove 113, and a heat pipe 114 bonded to the heat pipe bonding groove (See, e.g., JP-B-3413151 and JP-B-3413152).

FIG. 11B shows another conventional heat sink 111b that is composed of plural separate radiation fins 115 each of which is plate-shaped and has a heat pipe bonding hole 116, and a heat pipe 117 inserted and bonded to the heat pipe bonding hole 116.

However, the conventional heat sinks 111a and 111b cause the problem that the assembly cost is high since they are composed of the separate radiation fins 112, 115.

Further, the conventional heat sinks 111a and 111b cause the problem that the assembly workability is low when the separate radiation fins 112, 115 are reduced in thickness.

Therefore, the conventional heat sinks 111a and 111b need provide the separate radiation fins with a certain thickness, where it cannot attain the weight saving.

Further, the conventional heat sinks 111a and 111b have the problems that the assembly time required lengthens according to the number of the radiation fins, and that the assembly pitch of the separate radiation fins needs to be adjusted each time.

### SUMMARY OF THE INVENTION

It is an object of the invention to provide a heat sink that is low-profile, light-weight, excellent in assembly workability, low-cost due to using parts suited for mass production, and provided with a utilizable large heat transfer area.

(1) According to one embodiment of the invention, a heat sink comprises:

a heat pipe inside of which a working fluid is filled and which is extended by a predetermined length from a heat source in a heat radiation direction; and

a radiation fin comprising a mountain portion and a valley portion formed in a longitudinal direction of the heat pipe, the mountain portion and the valley portion composing a continuous waveform,

wherein the radiation fin further comprises a step portion for fitting and retaining the heat pipe thereinto.

In the above embodiment (1), the following modifications, changes and a combination thereof can be made.

(i) The mountain portion of the radiation fin comprises the step portion that comprises a cut part cut along both sides of the heat pipe and a folded part with a predetermined height from the valley portion.

(ii) The step portion comprises a furthest face end that is extended outside developing outward the folded part of the mountain portion and retains the heat pipe.

(iii) The heat pipe is elliptical or rectangular in cross section, and

the step portion is shaped to fit a cross-section form of the heat pipe.

(iv) The heat sink further comprises:

a holding board that covers the heat pipe fitted and retained into the radiation fin and is bonded to the radiation fin.

(v) The mountain portion of the radiation fin comprises the step portion comprising a cut part to fit the heat pipe into the mountain portion.

(2) According to another embodiment of the invention, a method of making the heat sink as defined by the above embodiment (1) comprises:

shaping the mountain portion and the valley portion on a strip plate member with a thermal conduction property in a longitudinal direction of the plate member to form the radiation fin;

placing the radiation fin between an upper mold and a lower mold, wherein the upper mold comprises a convex member with a same shape as the heat pipe and the lower mold comprises a step-shaping member for shaping the step portion;

pressing the radiation fin by the upper mold and the lower mold to form the step portion on the mountain portion; and

fitting and retaining the heat pipe into the step portion.

### Advantages of the Invention

By the invention, a heat sink can be provided that is excellent in assembly workability, low-cost, and provided with a large heat transfer area.

### BRIEF DESCRIPTION OF THE DRAWINGS

The preferred embodiments according to the invention will be explained below referring to the drawings, wherein:

FIG. 1 is a perspective view showing a heat sink in a first preferred embodiment according to the invention;

FIG. 2A is an enlarged perspective view showing a radiation fin 3 in FIG. 1 before forming a step portion 4 as well as a convex member 21;

FIG. 2B is an enlarged perspective view showing the radiation fin 3 with the step portion 4;

FIG. 2C is an enlarged longitudinal sectional view showing a part of the heat sink in FIG. 1 as well as heat flow;

FIG. 2D is a top view showing the part of the heat sink in FIG. 2C;

FIG. 2E is an illustration showing the sequence of heat flow;

FIG. 3 is a perspective view showing a heat sink in a second preferred embodiment according to the invention;

FIG. 4 is a perspective view showing a heat sink in a third preferred embodiment according to the invention;

FIG. 5A is a front view showing the heat sink in FIG. 4 viewed from one end of a heat pipe 2;

FIG. 5B is a side view showing the heat sink in FIG. 5A;

FIG. 5C is a back view showing the heat sink in FIG. 4 viewed from the other end of the heat pipe 2;

FIG. 5D is an enlarged side view showing a part of the heat sink in FIG. 5B;

FIG. 5E is a longitudinal sectional view showing the heat sink in FIG. 5B cut along the heat pipe 2;

FIG. 5F is an illustration showing the sequence of heat flow;

FIG. 6 is a schematic perspective view showing a step in a method of making the heat sink in FIG. 4;

FIG. 7 is a schematic perspective view showing a step following the step in FIG. 6;

FIG. 8 is a schematic perspective view showing a step following the step in FIG. 7;

FIG. 9A is an enlarged perspective view showing a radiation fin 93 in a fourth preferred embodiment according to the invention before forming a step portion 94;

FIG. 9B is an enlarged perspective view showing the radiation fin 93 with the step portion 94;

FIG. 9C is an enlarged longitudinal sectional view showing a part of a heat sink in the fourth embodiment as well as heat flow;

FIG. 9D is a top view showing the part of the heat sink in FIG. 9C;

FIG. 9E is an illustration showing the sequence of heat flow;

FIG. 10A is a side view showing a heat sink in a fifth preferred embodiment according to the invention;

FIG. 10B is a longitudinal sectional view showing the heat sink in FIG. 10A cut along the heat pipe 2;

FIG. 10C is an illustration showing the sequence of heat flow;

FIG. 11A is a longitudinal sectional view showing the conventional heat sink cut along the heat pipe 114; and

FIG. 11B is a perspective view showing the other conventional heat sink.

### DETAILED DESCRIPTION OF THE PREFERRED EMBODIMENTS

Preferred embodiments of the invention will be described below referring to the attached drawings.

### First Embodiment

Construction of a Heat Sink of the First Embodiment

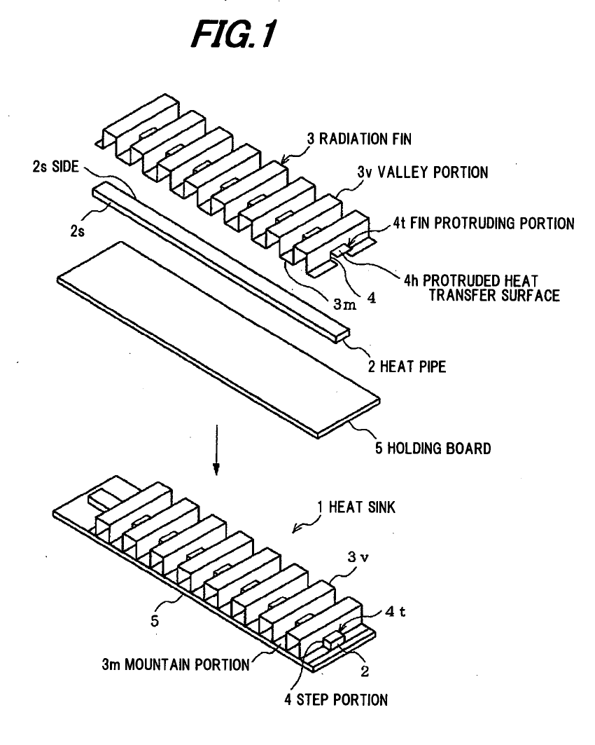

FIG. 1 is a perspective view showing a heat sink in the first preferred embodiment according to the invention.

As shown in FIG. 1, the heat sink of the first embodiment is composed of a heat pipe 2 including a working fluid encapsulated therein and extending a predetermined length in heat radiation direction (i.e., in oblique direction from the top-left end to the bottom-right end in FIG. 1) from a heat source (not shown), and an integral radiation fin 3 wave-shaped (or corrugated) along the longitudinal direction of the heat pipe 2.

The heat pipe 2 is formed with a metallic tube such as a copper tube with a high heat radiation property, includes a working fluid such as water and alcohol encapsulated therein, and severs to transfer heat by means of the phase change between evaporation and condensation of the working fluid. The working fluid is encapsulated under reduced pressure and is therefore phase-changed by a small temperature difference, where heat is transferred by vapor at speed close to the sonic speed and the working fluid condensed is then circulated inside the tube by the capillary action of wick (with capillary structure). Thereby, the heat pipe 2 can transfer heat from one end (at the top-left end in FIG. 1) to the other end (at the bottom-right end in FIG. 1).

The shape of the heat pipe 2 is not limited to circular in cross section and may be flattened such as elliptical or rectangular in cross section. In this embodiment, the heat pipe 2 rectangular-shaped in cross section is used.

The radiation fin 3 is formed with a heat-conductive strip plate member formed of Al or Cu etc. with high heat transfer property. In this embodiment, the radiation fin 3 is formed such that it is as a whole wave-shaped or corrugated with a rectangular mountain portion (or convex portion) 3m and a rectangular valley portion (or convex portion) 3v which are alternately formed. In FIG. 1, an example is shown that the pitches (i.e., a length along the longitudinal direction of the heat pipe 2) between the mountain portions 3m or between the valley portions 3v are set to be equal to each other.

At the middle (in the width direction) of each mountain portion 3m of the radiation fin 3, a step portion (or a heat pipe bonding groove) 4 for retaining and fitting up the heat pipe 2 is integrally formed on the mountain portion 3m. The step portion 4 is formed as a depressed step from the top of the mountain portion 3m. In detail, the step portion 4 is formed such that, when retaining and fitting up the heat pipe 2, the across-the-width surface (top or bottom surface) of the heat pipe 2 coincides with the top surface of the mountain portion 3m.

The step portion 4 is produced such that, according to the cross-section form of the heat pipe 2, each of the mountain portions 3m is cut along both sides 2s, 2s of the heat pipe 2 and is folded to have a predetermined height from the bottom of the valley portion 3v (See FIG. 1).

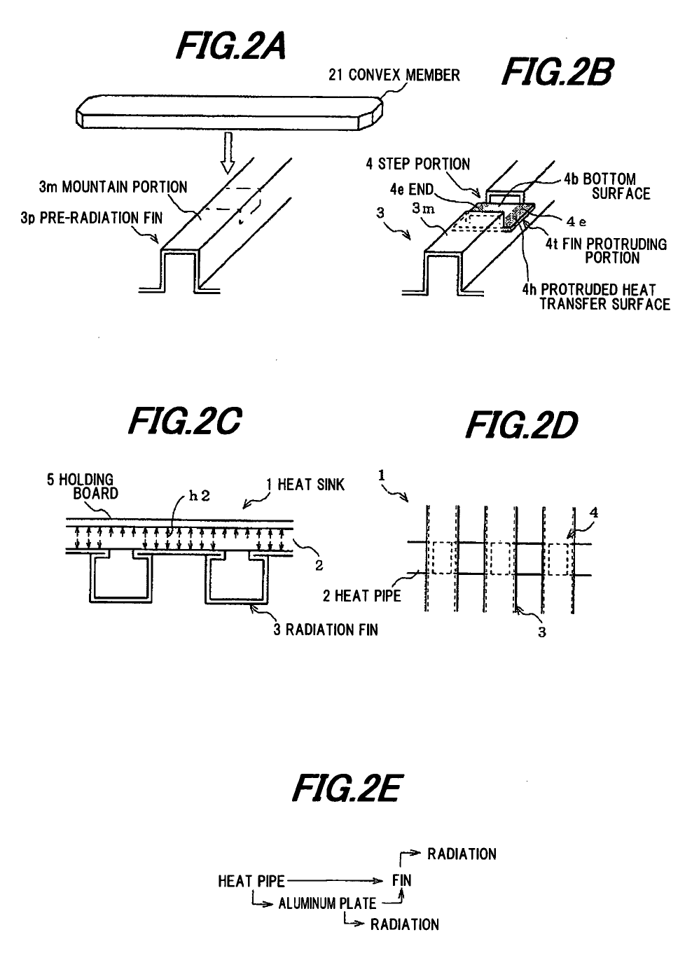

More in detail, the step portion 4 is produced such that furthest face ends (or both ends) 4e, 4e thereof (as shown by shaded areas in FIG. 2B) are extended outside developing outward (i.e., in the heat radiation direction or in the direction from the top-left end to the bottom-right end in FIG. 1) the folded part of each of the mountain portions 3m and retain the heat pipe 2. Thereby, the both ends 4e, 4e of each step portion 4 are formed to protrude in the longitudinal direction of the heat pipe 2 to have a protruded heat transfer surface 4h. Thus, the both ends 4e, 4e compose fin protruding portions 4t which protrude outside each of the step portions 4.

Further, the heat sink 1 is composed of a holding board (or base) 5 that is bonded onto the mountain portions 3m of the radiation fin 3 while covering the heat pipe 2 retained and fitted up by each of the step portions 4 of the radiation fin 3 (See FIG. 1). The holding board 5 is preferably formed of a metallic board, such as an aluminum board, made of Al etc. which is lightweight and has high heat radiation property.

Method of making the Heat Sink of the First Embodiment

A method of making the heat sink of the first embodiment will be briefly described below by referring to FIGS.2A and 2B, although a detailed method of the heat sink will be described later.

At first, a strip plate member formed of a heat conductive Al thin plate is provided. The plate member is folded to have a pre-radiation fin 3p with the mountain portions 3m and the valley portion 3v formed along its longitudinal direction as shown in FIG. 2A.

In order to form the step portion 4 on each of the mountain portions 3m of the pre-radiation fin 3p, a convex member 21 with substantially the same shape as the heat pipe 2 (See FIG. 1) is used when a shearing work is conducted incising each of the mountain portions 3m and a compression buckling is conducted pressing down by using a mold.

Thus, the radiation fin 3 is shaped to form the step portion 4 and the protruded heat transfer surface 4h together. The protruded heat transfer surface 4h of the step portion 4 is formed by spreading laterally (i.e., in the longitudinal direction of the heat pipe 2) the buckled part of each of the mountain portions 3m when pressing down each of the mountain portions 3m, so that a wide heat transfer area can be obtained.

Then, the heat pipe 2 is fitted and retained into the step portions 4 of the radiation fin 3. Here, as shown on the lower side in FIG. 1, the fitting is adjusted such that one end (i.e., the top-left end) of the heat pipe 2 protrudes longer than the other end (i.e., the bottom-right end) thereof from the radiation fin 3. In use, the heat source (not shown) such as an electrical parts and optical parts is attached to cover or contact the longer-protruded end of the heat pipe 2.

Then, the holding board 5 is bonded onto the mountain portions 3m of the radiation fin 3, so that the heat sink 1 can be obtained as shown on the lower side in FIG. 1 or FIG. 2D.

Effects of the First Embodiment

Effects of the first embodiment will be explained below.

In the heat sink 1, heat generated from the heat source is conducted from the one end to the other end of the heat pipe 2. In explanation below, a case is provided that heat radiation is observed at a position distant from the heat source, and rendered only through the heat pipe 2 while neglecting heat transfer from the heat source to the holding board (aluminum plate) 5.

As shown in FIG. 2C, the heat sink 1 is constructed such that the heat pipe.2 contacts directly the radiation fin 3. Therefore, heat generated from the heat source is, as shown by heat flow h2, directly conducted from the heat pipe 2 to the radiation fin 3, so that the heat transfer is so efficient. It is needless to say that the heat conduction path can be also formed through the holding board 5 from the heat source (See FIG. 2E).

The heat sink 1 can be easy assembled by fitting up and retaining the heat pipe 2 into the step portions 4 of the wave-shaped radiation fin 3 integrally formed. The radiation fin 3 can be produced continuously and it does not need the fine pitch adjustment in the assembly process as done in the conventional process where the separate radiation fins 3 are assembled. Thus, the heat sink 1 can be easy assembled or produced so that it is excellent in mass productivity.

Further, even when the radiation fin 3 is thinned (e.g., down to about 0.1 mm in thickness) for weight saving, it can secure a free-standing structure by itself. Thus, it is low-cost, excellent in mass productivity, and sufficient in mechanical strength.

The step portion 4 of the heat sink 1 is formed without cutting off the concerned part so that the bottom surface 4b (i.e., non-shaded area sandwiched by the shaded areas 4e) of the step portion 4 of the radiation fin 3 serves as a heat transfer surface to contact the heat pipe 2. Thus, a part of the step portion 4 can be utilized as the heat transfer surface to provide mainly the radiation fin 3 with the heat radiation function to enhance the entire heat radiation property.

In addition, the heat sink 1 has the protruded heat transfer surfaces 4h on both sides of the step portion 4, which contact the heat pipe 2 to provide for more efficient radiation structure between the heat pipe 2 and the radiation fin 3. Thus, the heat sink 1 can have a wider heat transfer area than before to enhance the heat radiation property.

In the heat sink 1, since the heat pipe 2 is fitted into the step portions 4 formed linearly on the wave-shaped radiation fin 3, the heat pipe 2 itself can serve as a self-jig during the assembly process and serve as a frame of the heat sink 1 after the assembly process. Thus, it can be easy manufactured and provided with the enhanced mechanical strength.

The radiation fin 3 is formed by wave-shaping, where the pitch, height or depth of the mountain portions 3m or the valley portions 3v can be easy changed (e.g., if the air can pass through a space defined by the mountain portion 3m and the valley portion 3v then the pitch is decreased, else the pitch is increased). Thus, the radiation fin 3 can be easy and precisely produced to provide the mountain portions 3m or the valley portions 3v with equal pitches. The radiation fin 3 can be easy design-changed according to the kind of a heat source or an electric device and optical device equipped with the heat source.

The heat sink 1 is suited especially to cool the heat source by natural convection. The heat sink 1 may be used for forced cooling of the heat source by using a fan etc.

The heat sink 1 uses the heat pipe 2 formed flattened such as rectangular in cross section, where the space occupied by the heat pipe 2 itself can be smaller than circular in cross section, and the heat pipe 2 can have the increased contact area with the radiation fin 3 and can be stably retained on the radiation fin 3.

The heat sink 1 is provided with the holding board 5, where the heat radiation property can be thereby enhanced and the heat pipe 2 can be thereby secured to the radiation fin 3.

### Second Embodiment

A heat sink 31 of the second preferred embodiment according to the invention will be described below.

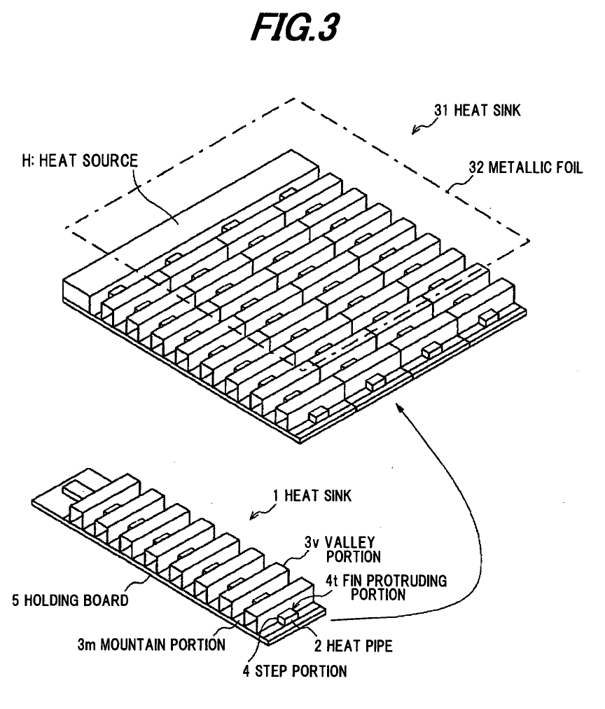

As shown in FIG. 3, the heat sink 31 of the second embodiment is constructed such that the plural heat sinks 1 (four heat sinks 1 in FIG. 3) are arranged in the width direction to be square when viewed from the top. In brief, the heat sink 31 is formed by bonding plural sets of basic structures, each set of which is composed of the heat pipe 2, the radiation fin 3 and the holding board 5, arranged in parallel.

A heat source H is disposed on the holding boards 5 on one side of the heat sink 31 to allow one protruded end of each the heat pipes 2 to be embedded (or inserted) therein. Further, the heat sink 31 is constructed such that a metallic foil 32 formed of Al etc. with high heat radiation property is attached covering all the radiation fins 3 and the heat source H disposed on the holding board 5.

The heat sink 31 can be, for example, attached to the back surface of a backlight equipped with LCD (liquid crystal display). The LCD backlight is provided with a light source such as a white LED (light emitting diode) array disposed on the side or top of a light guiding plate, where the light source corresponds to the heat source as described above.

Especially in case of a light source using a semiconductor device such as a white LED, heat from the LCD where the operable temperature is limited must be prevented from staying therein by means of cooling. By using the low-profile and lightweight heat sink 31, even in electric devices and optical devices such as the LCD with a relatively large cooling area, heat generated from the heat source H can be sufficiently radiated to cool down the light source.

Further, since the heat sink 31 is provided with the foil 32, heat generated from the heat source H can be radiated conducted through the heat pipe 2 and the radiation fin 3 to the foil 32. Thus, the heat radiation property can be further enhanced.

### Third Embodiment

A heat sink 41 of the third preferred embodiment according to the invention will be described below.

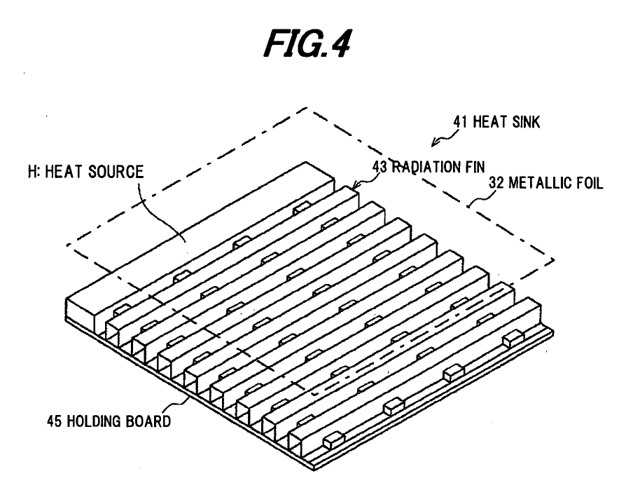

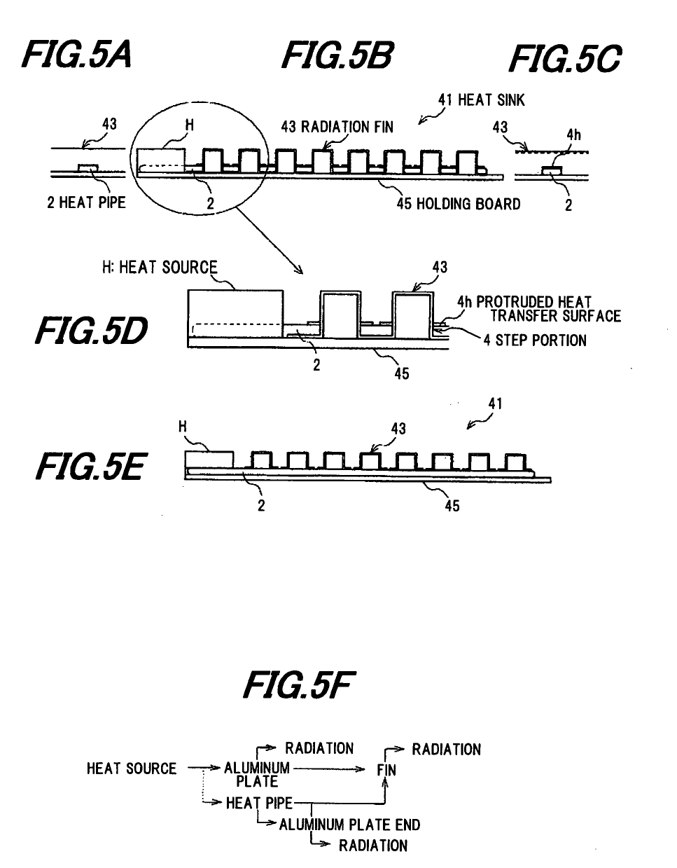

As shown in FIG. 4 and FIGS. 5A to 5E, the heat sink 41 of the third embodiment is constructed such that the plural radiation fins 3 of the heat sink 31 as shown in FIG. 3 are integrally formed to have a radiation fin 43 with a large area and the plural holding boards 5 thereof are integrally formed to have a holding board 45 with a large area.

In the heat flow of the heat sink 41, as shown in FIG. 5F, heat generated from the heat source H is conducted through the aluminum holding board 45 to the radiation fin 43, from which the conducted heat can be radiated externally. Simultaneously, it is conducted though the heat pipes 2 to the radiation fin 43 and the other end of the aluminum holding board 45, where the conducted heat can be radiated externally.

Method of Making the Heat Sink of the Third Embodiment

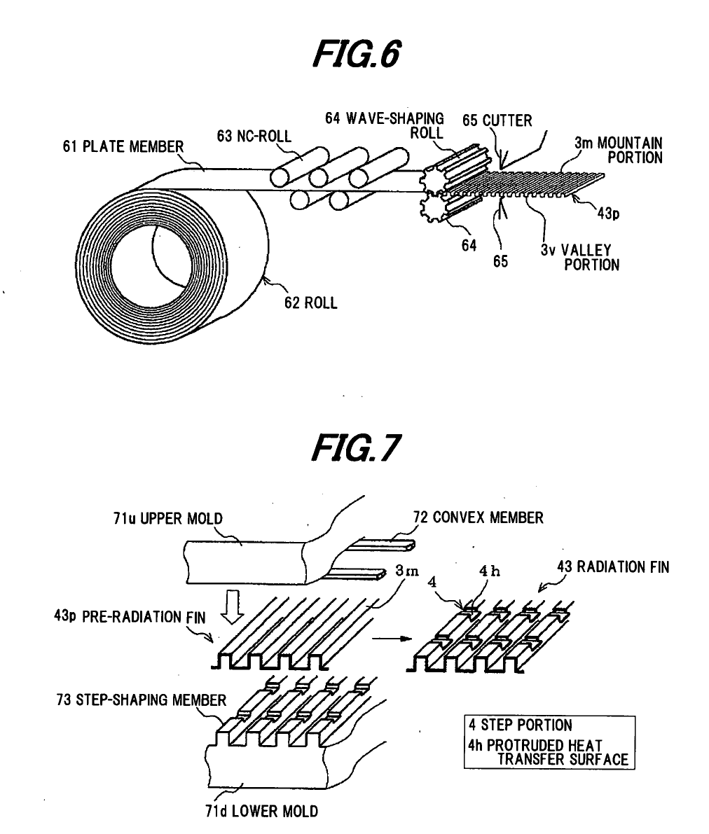

A method of making the heat sink 41 of the third embodiment will be described below referring to FIGS. 6 to 8.

At first, as shown in FIG. 6, a roll 62 is provided which is formed by winding a wide strip plate member 61 (with a width of about 400 mm) formed of a heat conductive Al thin plate. Then, the plate member 61 is rolled out from the roll 62 and sequentially forwarded downstream by an NC-roll 63. Then, the plate member 61 passes through between wave-shaping rolls 64, 64 vertically disposed downstream of the NC-roll 63, where the mountain portions 3m and valley portions 3v are formed along the longitudinal direction of the plate member 61. Then, the wave-shaped plate member 61 is cut off at each predetermined length by cutters 65, 65 vertically disposed downstream of the wave-shaping rolls 64, 64, where a wave-shaped pre-radiation fin 43p is obtained.

Then, as shown in FIG. 7, an upper mold 71u with plural convex members 72 with the same shape as the heat pipe 2 (See FIG. 1) formed (or attached) thereon is provided in advance as well as a lower mold 71d with a step-shaping member 73 for shaping the step portion 4. The pre-radiation fin 43p is press-molded vertically between the upper mold 71u and the lower mold 71d. Here, the press-molding is preferably conducted such that after the pre-radiation fin 43p is mounted on the lower mold 71d, the upper mold 71u is pressed down on the lower mold 71d. Thereby, the step portion 4 and the protruded heat transfer surface 4h are formed together by the pressing (shearing+buckling) to achieve the radiation fin 43.

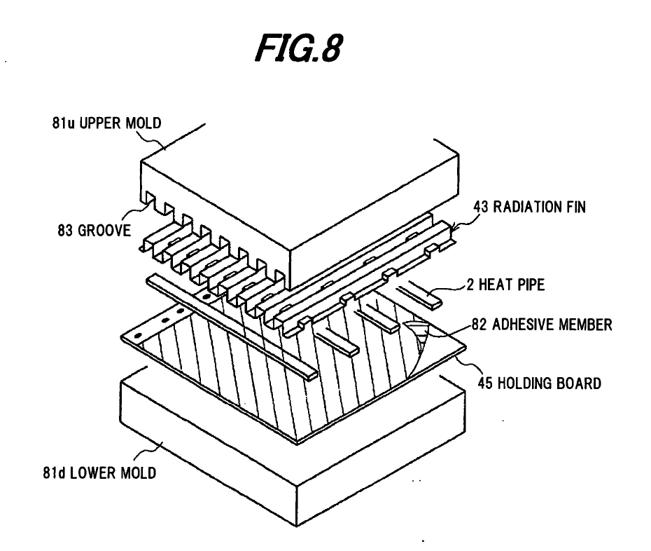

Then, as shown in FIG. 8, the heat pipes 2 are fitted and retained into the step portions 4 of the radiation fin 43.

Then, an adhesive member 82 formed of as an adhesive double coated tape or adhesive agent etc. is disposed on the holding board 45, and the radiation fin 43 with the heat pipe 2 retained thereto is disposed thereon. On the other hand, an assembling upper mold 81u with grooves 83 formed according to the wave shape of the radiation fin 43 is provided as well as an assembling lower mold 81d as a supporting base. The adhesive member 82 may be a conductive adhesive agent to enhance the heat radiation property.

Then, the holding board 45, the adhesive member 82 and the radiation fin 43 with the heat pipe 2 retained thereto are pressed vertically between the assembling upper mold 81u and the assembling lower mold 81d at normal temperature or raised temperature. Thereby, the holding board 45 can be bonded to the radiation fin 43 with the heat pipe 2 retained thereto to obtain the heat sink 41 as shown in FIG. 4.

By applying the method of making the heat sink 41 in the third embodiment, the heat sink 1 with the small area as shown in FIG. 1 can be easy produced as previously arranged by the molds as well as the heat sink 41 with the large area as shown in FIG. 4.

### Fourth Embodiment

A heat sink 91 of the fourth preferred embodiment according to the invention will be described below.

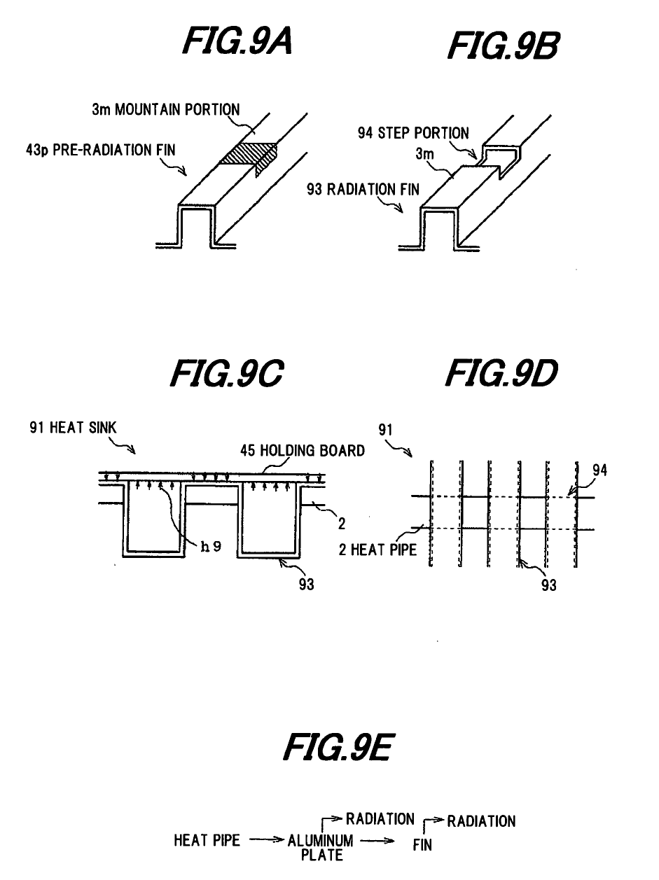

As shown in FIGS. 9A to 9D, the heat sink 91 of the fourth embodiment is constructed such that a part (i.e., a part defined by hatched lines in FIG. 9A) of the mountain portions 3m of the pre-radiation fin 43p is cut off to step portion 94 as shown in FIG. 9B to have a radiation fin 93.

As shown in FIG. 9C, in the heat sink 91 using the radiation fin 93, provided the same condition as shown in FIG. 2C is satisfied, heat generated from the heat source is, as shown by heat flow h9, conducted from the heat pipe 2 through the aluminum holding board 45 to the radiation fin 93, where it can be externally radiated from both of the aluminum holding board 45 and the radiation fin 93 (See FIG. 9E). Therefore, the heat sink 91 can have sufficient heat radiation property although it is somewhat inferior to the heat sink 1 as shown in FIG. 1 in heat transfer performance.

### Fifth Embodiment

A heat sink 101 of the fifth preferred embodiment according to the invention will be described below.

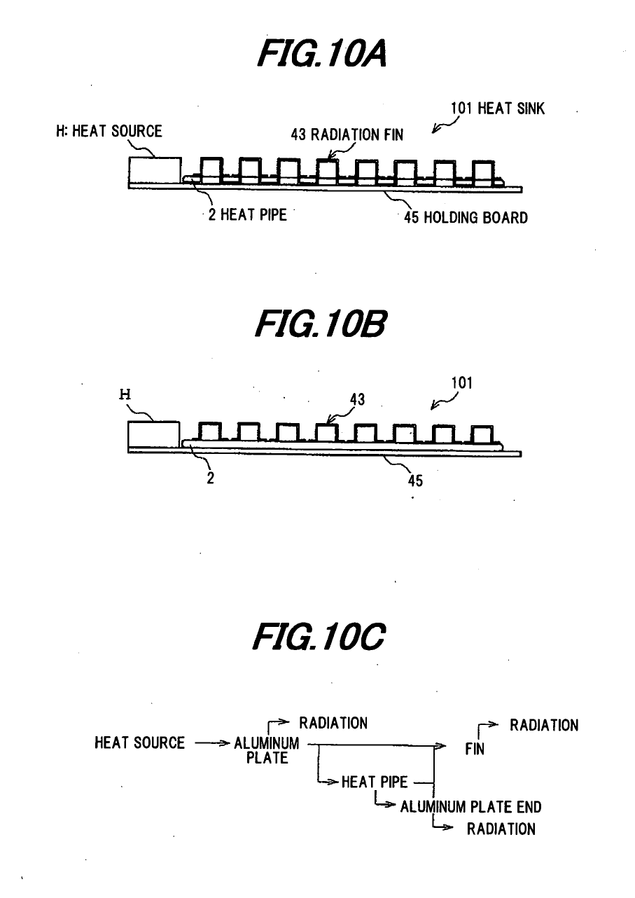

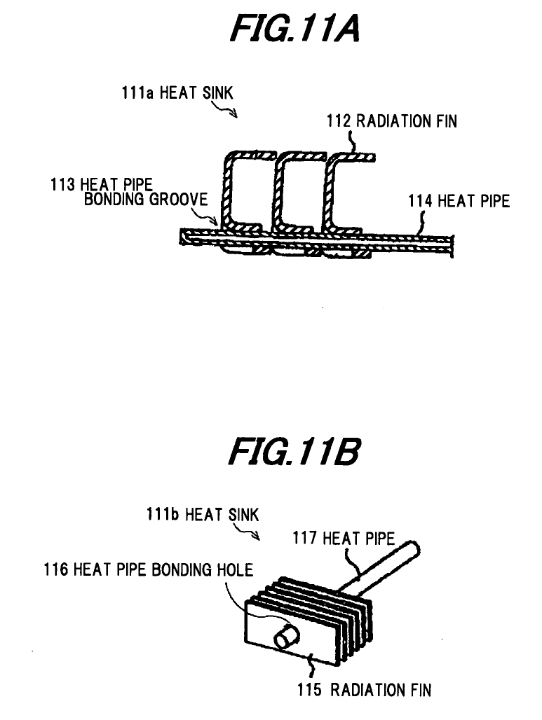

As shown in FIGS. 10A and 10B, the heat sink 101 of the fifth embodiment is constructed such that the heat pipe 2 is a little separated from the heat source H without directly contacting the heat source H to allow the indirect heat conduction through the holding board 45.

In the heat flow of the heat sink 101, as shown in FIG. 10C, heat generated from the heat source H is conducted through the aluminum holding board 45 to the radiation fin 43, where it can be externally radiated. Simultaneously, the heat is conducted through the aluminum holding board 45 to the heat pipe 2 and then through the heat pipe 2 to the radiation fin 43 and the other end of the aluminum holding board 45, where it can be externally radiated.

The heat sink 101 can have a merit that unevenness in temperature is less likely to occur between a site with the heat pipe 2 and a site without the heat pipe 2, although it is somewhat inferior to the heat sink 41 as shown in FIGS. 4 and 5A to 5E in heat transfer performance.

Although in the above embodiments, the step portion formed on the radiation fin is rectangular-shaped in longitudinal section, it may be concaved in any shape.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A heat sink, comprising:
a heat pipe inside of which a working fluid is filled and which is extended by a predetermined length from a heat source in a heat radiation direction; and
a radiation fin comprising a mountain portion and a valley portion formed in a longitudinal direction of the heat pipe, the mountain portion and the valley portion composing a continuous waveform,
wherein the radiation fin further comprises a step portion for fitting and retaining the heat pipe thereinto.

2. The heat sink according to claim 1, wherein:
the mountain portion of the radiation fin comprises the step portion that comprises a cut part cut along both sides of the heat pipe and a folded part with a predetermined height from the valley portion.

3. The heat sink according to claim 2, wherein:
the step portion comprises a furthest face end that is extended outside developing outward the folded part of the mountain portion and retains the heat pipe thereon.

4. The heat sink according to claim 1, wherein:
the heat pipe is elliptical or rectangular in cross section, and the step portion is shaped to fit a cross-section form of the heat pipe.

5. The heat sink according to claim 1, further comprising:
a holding board that covers the heat pipe fitted and retained into the radiation fin and is bonded to the radiation fin.

6. The heat sink according to claim 1, wherein:
the mountain portion of the radiation fin comprises the step portion comprising a cut part to fit the heat pipe into the mountain portion.

7. A method of making the heat sink according to claim 1, comprising:
shaping the mountain portion and the valley portion on a strip plate member with a thermal conduction property in a longitudinal direction of the plate member to form the radiation fin;
placing the radiation fin between an upper mold and a lower mold, wherein the upper mold comprises a convex member with a same shape as the heat pipe and the lower mold comprises a step-shaping member for shaping the step portion;
pressing the radiation fin by the upper mold and the lower mold to form the step portion on the mountain portion; and
fitting and retaining the heat pipe into the step portion.
